(19) United States
(12) Patent Application Publication
(10) Pub. No.: US 2025/0309711 A1
(43) Pub. Date: Oct. 2, 2025

(54) AXIAL FLOW MACHINE FOR A MOTOR VEHICLE, IN PARTICULAR FOR AN AUTOMOBILE

(71) Applicant: MERCEDES-BENZ GROUP AG, Stuttgart (DE)

(72) Inventors: Peter APPELTAUER, Fellbach (DE); Tobias HAERTER, Stuttgart (DE)

(21) Appl. No.: 18/864,109

(22) PCT Filed: Apr. 19, 2023
(86) PCT No.: PCT/EP2023/060178

§ 371 Date: Nov. 8, 2024

(30) Foreign Application Priority Data
May 12, 2022 (DE) 10 2022 001 674.5

(51) Int. Cl. H02K 1/2798; H02K 7/00; H02K 7/116

(52) U.S. Cl. CPC H02K 1/2798; H02K 7/006; H02K 7/116

(57) ABSTRACT

An axial flow machine for a motor vehicle has a stator and two rotors that can rotate relative to the stator. The stator is arranged between the rotors in an axial direction of the axial flow machine. Sides of the rotors facing towards each other in the axial direction each have first toothing segments arranged one after the other in a circumferential direction of the axial flow machine and spaced apart from each other, and each have second toothing-free segments, arranged in a circumferential direction of the axial flow machine between the first toothing segments. Second segments of a first of the sides and second segments of the second side are spaced apart from each other in the axial direction so that a respective air gap is arranged in the axial direction between the second segments of the first side and the second segments of the second side.

### BACKGROUND AND SUMMARY OF THE INVENTION

Exemplary embodiments of the invention relate to an axial flow machine for a motor vehicle, in particular for an automobile.

Such an axial flow machine for a motor vehicle, in particular for an automobile, is already known from DE 10 2021 006 008, for example. The axial flow machine has a stator and two rotors that can rotate relative to the stator, wherein the stator is arranged in an axial direction of the axial flow machine between the rotors.

Exemplary embodiments of the present invention are directed to improving an axial flow machine of the type mentioned above.

In order to improve an axial flow machine it is provided according to the invention that sides of the rotors facing towards each other in the axial direction each have toothing segments as first segments, which are arranged one after the other in the circumferential direction of the axial flow machine and spaced apart from each other and have a respective toothing. The first segments are also referred to as toothed segments. Furthermore, the sides facing towards each other have toothing-free, second segments, in which no toothing is formed. The second segments are spaced apart from each other in the circumferential direction of the axial flow machine extending around the axial direction of the axial flow machine and are arranged one after the other and between the toothing segments, in particular in such a way that the respective toothing segments and the respective second segments of the respective side follow one another alternately in the circumferential direction of the axial flow machine. Thus, viewed in the circumferential direction of the axial flow machine, a toothing-free, i.e., non-toothed, second segment of the respective side, and in particular just one, is arranged between two neighboring toothing segments of the respective side.

The second segments of a first of the sides and the second segments of the second side face towards each other in the axial direction of the axial flow machine and are spaced apart from each other in the axial direction of the axial flow machine so that at least one respective air gap is arranged in the axial direction of the axial flow machine between the second segments of the first side and the second segments of the second side. Thus, the invention provides that only individual segments are toothed on the circumference, and that the non-toothed segments of the two sides are not in mutual contact and there is at least one air gap between them. Therefore, a time-efficient and thus cost-effective machining time of the sides can be realized so that the axial flow machine can be produced time-efficiently and cost-effectively.

In an advantageous embodiment of the invention, it is provided that the toothings are designed as Hirth toothings.

In an advantageous embodiment of the invention, it is provided that three regions are toothed on the circumference of each rotor.

In an advantageous embodiment of the invention, it is provided that the two rotors are screwed to each other in the region of the toothing-free, second segments via one expansion screw in each case and are thereby braced against each other.

In an advantageous embodiment of the invention, it is provided that a sealing sleeve is provided below the toothing.

In an advantageous embodiment of the invention, it is provided that a marking is provided on the circumference of each rotor.

In an advantageous embodiment of the invention, it is provided that on each of the toothed first segments of each rotor, a number of teeth of the toothing changed by at least one tooth compared to the other toothing segments is provided.

An advantage of screwing the rotors together in the region of the non-toothed segments via one expansion screw in each case is that multiple expansion screws can be used, since the expansion screws can be arranged in parallel or on a radius with the toothing. There is no need to use a hollow screw to save on radial installation space.

An advantage of the marking is that when the rotors are balanced together, an assembly of the axial flow machine is possible with the same angular position of the rotors relative to each other in which the rotors have been balanced together previously.

An advantage of the number of teeth changing by one tooth is that when assembling the axial flow machine, incorrect installation can be avoided or the probability of such incorrect installation can be kept particularly low.

In comparison to such a design in which the entire, respective side of the respective rotor is provided with a toothing designed as a Hirth toothing for example, i.e., a toothing extending continuously in the circumferential direction of the axial flow machine, such as a Hirth toothing for example, is or will be formed on the respective side, the invention can reduce a process time for manufacturing the toothing segments, in particular without having to accept functional disadvantages. As a result, they can be manufactured particularly cost-effectively. The invention also takes into consideration that the balancing quality of the rotors is a key quality hallmark of high-speed axial flow machines. The invention makes it possible to transfer a balancing quality of the rotors, achieved by means of the balancing machine and thus by balancing, to the finished axial flow machine without compromises and particularly cost-effectively, in particular in that the toothings allow the rotors to be advantageously connected to each other in a rotationally fixed manner and in particular to be precisely aligned relative to each other, in particular when viewed in the circumferential direction of the axial flow machine.

In particular, the invention is based on the following findings and considerations: Axial flow machines are known according to the prior art in two different designs. With the so-called H arrangement, two disc-shaped rotors as magnet carriers enclose a central stator, which is fixed to the housing and carries the energized coils. With the other, so-called I arrangement, a central rotor is arranged between two stators. In the following, an H arrangement is adopted, as known from the state of the art from WO 2021/032236 A1, for instance.

The annular disc-shaped air gap between the stator and the two rotors is preferably very narrow in an axial direction relative to the rotational axis of the axial flow machine, also referred to as a motor, which is also referred to as an electric engine, electric machine, or electric motor. Particularly for motors that operate at rotational high speeds, in the range of 15,000 revolutions per minute or even higher, it is important to keep the air gaps largely oil-free during the entire operation, not only for electromagnetic reasons but also for mechanical efficiency reasons, in order to avoid shear losses that would otherwise occur if oil or even oil mist were to enter the air gap in significant quantities. On the other hand, at the rotational speeds mentioned and with the narrow air gap between the rotors and the stator, a preferably broad-based roller bearing of the rotors is particularly advantageous. Such a bearing, especially at high rotational speeds, is preferably permanently supplied with fresh oil in order to ensure sufficient lubrication and cooling of the rolling elements over an adequate service life. In the narrow, disc-shaped air gaps, it is also advantageous from the point of view of the mechanical efficiency of the motor to prevent air circulation from the inside diameter to the outside as far as possible.

One feature of a toothing designed in particular as a Hirth toothing according to the state of the art is, in particular, that it is self-centering and ensures advantageous reproducibility of the mutual position of the two rotors in relation to each other during repeated assembly. It also has a high torque transmission capacity, which is comparable to that of a hollow shaft with a Hirth toothing at each shaft end. As other strength and rigidity criteria are also used for dimensioning in the hub area, a Hirth toothing over the entire area usually exceeds the requirements for its torque transmission capacity many times over. Therefore, according to the invention, only the individual first segments are toothed on the circumference. One way to achieve this, for example, is to only machine a certain number of teeth segment by segment and to omit others in the sense that they are not machined. Depending on requirements, for example, three complete teeth can be finished on each of just three segments evenly distributed around the circumference. The division of the full circumferential toothing is retained, which means that there are no losses, neither for the formation of a uniform contact pattern of the tooth flanks in contact with each other, nor for self-centering via the Hirth toothing segments. In the region of the non-toothed, second segments, it is possible according to the invention to screw the two rotors together using one expansion screw in each case. The ultimately selected number of machined toothing segments, also known as tooth segments, of the respective machined teeth per segment and thus also the number of expansion screws evenly distributed over the circumference result from the torque capacity of the motor, the dimensions of the hollow shaft of the rotors and/or from other geometric boundary conditions. For example, three complete teeth are machined into each of three segments evenly distributed around the circumference, wherein the rotors are screwed together with three expansion screws arranged between the toothed segments. These expansion screws also offer the additional advantage that, if properly screwed in, they are self-locking for the entire service life of the axial flow machine, also known as a power unit, and therefore no further screw locking measures are required. The contact between the two rotors is effected exclusively via the tooth flanks of the toothings preferably designed as Hirth toothings. The non-toothed, second segments of the two rotors are not in contact with each other; there is at least one air gap between them, which may be large for weight reasons. By dispensing with the machining of a number of teeth of the Hirth toothing, the necessary machining time can be shortened proportionally and thus also the manufacturing costs can also be reduced, without having to accept any functional losses.

A particularly advantageous feature of the rotors of an axial flow machine in a H arrangement or H design, which are joined by means of self-segmented Hirth toothing, also results from the fact that the rotors can be balanced as an assembly, in which case they are preferably accommodated in the balancing machine via the diameters of the bearing points and are preferably balanced in two planes, in each case corresponding to the two rotor discs in the screwed together state. A particular advantage results from the fact that, after balancing and any further work on the rotor halves that does not affect the state of balance, the balancing accuracy achieved in the balancing process can be transferred to the finished power unit better during final assembly of the rotors than would be possible with other methods due to the mutual position reproducibility of the Hirth toothing during successive assemblies. Rotors balanced together during assembly must be handled as a pair. During final assembly, the rotors should be mounted in the same angular position as they are balanced, which can be achieved either by the aforementioned marking or, particularly favorably, by a poka-yoke method. For example, it makes sense in this case to change the number of teeth of the Hirth toothing on one of the toothed segments by one tooth compared to the other segments.

An advantage that is particularly important for high-speed axial flow machines is optimum noise behavior, also known as NVH behavior (NVH-Noise Vibration Harshness), which is made possible by maintaining the balancing quality achieved on the balancing machine, both with regard to the radial unbalance of both discs and any torque unbalance that may otherwise result. This minimizes the vibration excitation transmitted to the housing via the bearing points.

In order to prevent oil and/or air circulation through the air gaps between the rotors and the stator, or advantageously to minimize it, a sealing sleeve is provided below the Hirth toothing.

Further advantages, features and details of the invention can be seen from the following description of a preferred exemplary embodiment and with reference to the drawing. The features and combinations of features mentioned above in the description as well as the features and combinations of features mentioned below in the description of the figures and/or shown alone in the figures can be used not only in the combination indicated in each case, but also in other combinations or on their own, without leaving the scope of the invention.

### BRIEF DESCRIPTION OF THE DRAWING FIGURES

The drawing shows in:

FIG. 1 a schematic and perspective longitudinal sectional view of a rotor device for an axial flow machine;

FIG. 2 a schematic perspective view of the rotor device; and

FIG. 3 a schematic perspective view of a rotor of the rotor device.

In the figures, identical or functionally identical elements are provided with the same reference signs.

### DETAILED DESCRIPTION

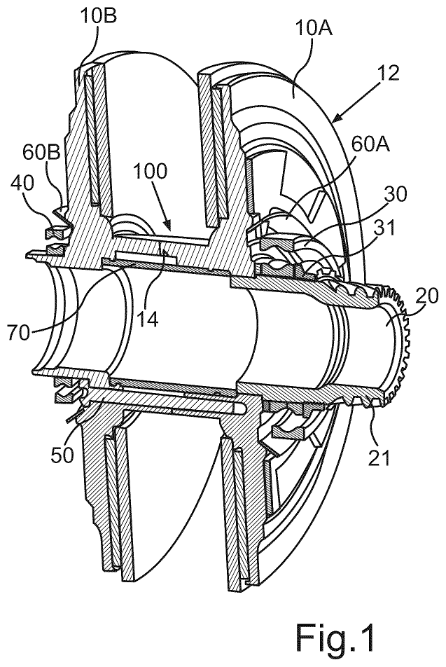

FIG. 1 shows a rotor device, denoted by 12, for an axial flow machine of a motor vehicle, in particular an automobile. In its fully produced state, the axial flow machine, also referred to as a motor or power unit, has a stator and the rotor device 12, which has a first rotor 10A and a second rotor 10B. In an axial direction of the axial flow machine, the stator is arranged between the rotors 10A and 10B. The rotors 10A and 10B, i.e. the rotor device 12, can be driven by means of the stator, and are thereby driven around a machine rotational axis relative to the stator, the axial direction of the axial flow machine coinciding with the machine rotational axis. In FIG. 1, a shaft stub output drive is denoted by 20, a running or driving toothing also known as output drive is denoted by 21, a fixed bearing is denoted by 30, a shaft nut is denoted by 31, a floating bearing is denoted by 40, an expansion screw is denoted by 50, a first oil baffle is denoted by 60A, a second oil baffle is denoted by 60B, a sealing sleeve is denoted by 70, and a toothed segment is denoted by 100, where, because the segment 100 is toothed, the segment 100 has a toothing designed as a Hirth toothing.

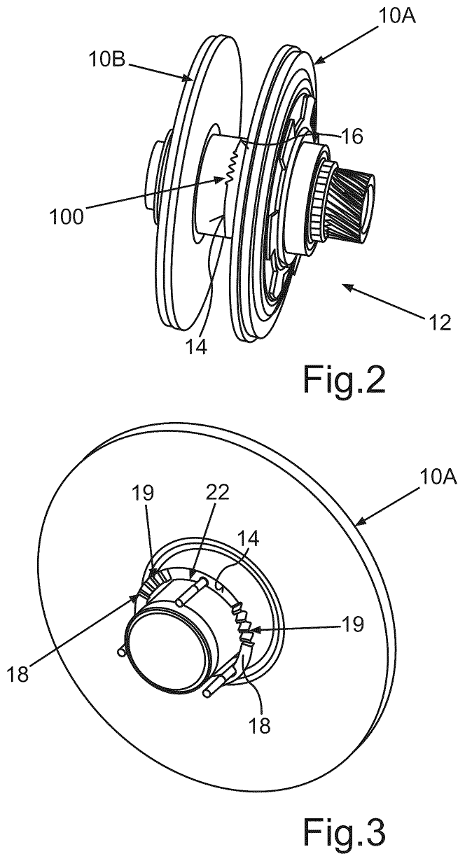

It can be seen from FIG. 1 that the rotor 10A has a first side 14, which in particular is a first end face of the rotor 10A. In a combined view with FIG. 2, it can be seen that the second rotor 10B has a second side 16 which in particular is a second end face. The sides 14 and 16 are opposite each other in the axial direction of the axial flow machine. As can be seen from FIG. 3, using the example of the rotor 10A, the respective side 14, 16 has several toothing segments 18 which are also referred to as first segments. The toothing segments 18 are arranged one after the other in the circumferential direction of the axial flow machine 10 and are spaced apart from each other. Furthermore, the respective toothing segment 18 has a respective toothing 19 which is preferably designed as a Hirth toothing. Furthermore, it can be seen from FIG. 3, using the example of the side 14 of the rotor 10A, that the respective side 14, 16 has second segments 22, which are toothing-free, i.e., non-toothed segments, wherein the respective second segments 22 are arranged one after the other in the circumferential direction of the axial flow machine and are spaced apart from each other. The respective second segment 22 of the respective side 14, 16 is free from toothing. The toothing-free, second segments 22 and the toothing segments 18 of the respective side 14, 16 are arranged alternately one after the other in the circumferential direction of the axial flow machine so that, as can be seen particularly well from FIG. 3, a toothing-free segment 22 of the respective side 14, 16, and in particular just one, is arranged between two neighboring toothing segments 18 of the respective side 14, 16.

In the segment denoted by 100 in FIG. 1, one, and in particular just one, of the toothing segments 18 of the side 14 meshes with one, and in particular just one, of the toothing segments 18 of the side 16, wherein, for example, the respective intermeshing toothing segments 18 of the sides 14 and 16 form a respective Hirth toothing or a respective Hirth toothing segment.

The toothing-free segments 22 of the side 14 and the toothing-free segments 22 of the side 16 are opposite each other in the axial direction of the axial flow machine 10 and face towards each other, wherein the toothing-free segments 22 of the side 14 and the toothing-free segments 22 of the side 16 are spaced apart from each other in the axial direction of the axial flow machine, so that, in the axial direction of the axial flow machine, at least one respective air gap is arranged between the respective toothing-free segment 22 of the side 14 and the respective toothing-free segment 22 of the side 16 facing towards the toothing free segment 22 of the side 14. This means that the toothing-free segments 22 of the side 14 do not contact the toothing-free segments 22 of the side 16.

Thus, for example, several segments 100 following each other in the circumferential direction of the axial flow machine and spaced apart from each other are provided, wherein the respective, toothed segment 100 in each case comprises a toothing segment 18 of the side 14 and a toothing segment 18 of the side 16. It is preferably provided that the toothings 19 of a first of the segments 100 have a respective, in particular the same, first number of teeth, and for example, the toothings 19 of a second of the segments 100 have a respective, preferably the same, second number of teeth. Preferably, the second number of teeth differs from the first number of teeth, in particular by at least or exactly one tooth. As a result, secure and simple mounting can be ensured.

### LIST OF REFERENCE SIGNS

10A rotor
10B rotor
12 rotor device
14 side
16 side
18 toothing segment
19 toothing
20 shaft stub output drive
21 running or driving toothing
22 toothing-free segment
30 fixed bearing
31 shaft nut
40 floating bearing
50 expansion screw
60A oil baffle
60B oil baffle
70 sealing sleeve
100 segment

1-7. (canceled)

8. An axial flow machine for a motor vehicle, the axial flow machine comprising:
a stator; and
two rotors configured to rotate relative to the stator, wherein the stator is arranged between the two rotors in an axial direction of the axial flow machine,
wherein the two rotors each include a first side facing towards the other one of the two rotors in the axial direction and a second side facing away from the other one of the two rotors in the axial direction,
wherein the first sides of the two rotors each have first segments and second segments,
wherein the first segments of the two rotors are toothing segments arranged one after the other on the respective one of the two rotors in a circumferential direction of the axial flow machine, wherein the first segments of the respective one of the two rotors are spaced apart from each other on the respective one of the two rotors, and the first segments of the two rotors have a respective toothing,
wherein the second segments are free of toothing, wherein the second segments are arranged one the respective one of the two rotors in the circumferential direction between the first segments, and
wherein the second segments of the first sides of the two rotors are spaced apart from each other in the axial direction so that a respective air gap is arranged in the axial direction between the second segments of the first side of one of the two rotors and the second segments of the first side of the other one of the two rotors.

9. The axial flow machine of claim 8, wherein the respective toothings are Hirth toothings.

10. The axial flow machine of claim 8, wherein each of the two rotors includes three first segments on a circumference of the respective one of the two rotors.

11. The axial flow machine of claim 8, wherein the two rotors are screwed to each other in a region of the second segments via one expansion screw in each case and the two rotors are thereby braced against each other.

12. The axial flow machine of claim 8, further comprising:
a sealing sleeve is arranged below the respective toothings.

13. The axial flow machine of claim 8, wherein a marking is provided on a circumference of each rotor.

14. The axial flow machine of claim 8, wherein a number of the respective toothings on each of the first segments of each of the two rotors is different by at least one tooth.
